(19) United States
(12) Patent Application Publication
(10) Pub. No.: US 2013/0144782 A1
(43) Pub. Date: Jun. 6, 2013

(54) ELECTRONIC INVOICE PAYMENT PREDICTION SYSTEM AND METHOD

(71) Applicant: Bottomline Technologies (DE) Inc., Portsmouth, NH (US)

(72) Inventors: Robert Arntz Eberle, North Hampton, NH (US); Amy Beth Hoke, Gilford, NH (US); Donna Louise Sawyer, Windham, NH (US); Michael Anthony Marcinelli, North Andover, MA (US)

(73) Assignee: Bottomline Technologies (DE) Inc., Portsmouth, NH (US)

(21) Appl. No.: 13/755,742

(22) Filed: Jan. 31, 2013

Related U.S. Application Data
(63) Continuation-in-part of application No. 13/068,558, filed on May 13, 2011.

(51) Int. Cl. G06Q 10/10

(52) U.S. Cl. CPC G06Q 20/102
USPC 705/40

(57) ABSTRACT

A system and method is presented for predicting a status change of a particular invoice from among a plurality of invoices within a database, where an invoice status relates to an event occurring in a timeline of events associated with payment of the invoice. The system and method may predict when the status of the particular invoice will change by analyzing those invoices of the plurality of invoices that are associated with a given buyer, where the given buyer is the buyer associated with the particular invoice. The prediction may be a function of the date of a previous event in the sequence of events associated with the particular invoice and an average timeline of events associated with payment of invoices by the given buyer.

### RELATED APPLICATIONS

This application is a continuation-in-part of application Ser. No. 13/068,558 filed on May 13, 2011.

### TECHNICAL FIELD

The present invention relates to electronic delivery of invoices and more particularly, to a system for predicting a status of an invoice by analyzing, with respect to the buyer of the invoice, past invoice activity.

### BACKGROUND OF THE INVENTION

Traditional invoice presentment and payment solutions between vendors and their buyers include paper-based invoice presentment and payment. In this scenario, the steps required to send an invoice (on the vendor's side), receive and approve the invoice, and pay the invoice (on the buyer's side) relies on a series of paper-based procedures. Recently, electronic invoicing and payment system have been developed that provide on-line invoice presentment that include means for reporting invoice approval and payment status to the vendor.

While the electronic invoicing and payment systems may provide the current payment status of an invoice, they do not provide any information regarding when payment for an invoice will be received. For example, a vendor may have dozens or hundreds of invoices corresponding to large sums of money for which the vendor is awaiting payment. The vendor may be unable to plan future purchases or estimate its ability to pay bills in the weeks and months to come, because the vendor cannot predict when it will receive payment for the invoices.

Therefore, there exists a need for a system or method that provides a prediction of the status of an invoice.

### SUMMARY OF THE INVENTION

The present invention provides a system for predicting a status change of an invoice by analyzing, for a buyer to which the invoice is directed, a plurality of invoices in the approval process directed to that buyer.

A first aspect of the present invention relates to an invoice status prediction system. The invoice status prediction system includes a database encoded to a non-transitory computer readable medium. The database includes a plurality of records, each representing an invoice, a portion of which are unpaid invoices, at least a first portion of the invoices relating to invoice activity of a first buyer and at least a second portion relating to invoice activity of a second buyer. The invoice status prediction system also includes a network interface configured to enable updating a status of at least one event among multiple events occurring in a timeline of events associated with payment of at least one invoice of the plurality of invoices. The invoice status prediction system additionally includes a processor configured to analyze the plurality of invoices within the database with respect to a given buyer and predict a status change among one or more events associated with payment of a particular invoice among the plurality of invoices by the given buyer.

According to one embodiment, the processor is configured to analyze the plurality of invoices within the database for the given buyer to predict a status of the particular invoice as of a preselected date.

According to another embodiment, the processor is configured to predict, for the given buyer, a status of multiple invoices as of the preselected date.

According to another embodiment, the processor is configured to analyze the plurality of invoices within the database for the given buyer to predict a date of status change, the date of status change representing a predicted date that a status of the particular invoice will change to a defined status.

According to another embodiment, the processor is configured to predict, for each of multiple invoices corresponding to the given buyer, the date of status change to the defined status.

According to another embodiment, the processor is further configured to output a prediction report. The prediction report includes a first field and a second field. The first field includes a ribbon having multiple statuses. One status of the multiple statuses is selected as a selected status. The second field includes a listing of at least one invoice, a current status of the at least one invoice corresponding to the selected status, from the plurality of invoices corresponding to the given buyer. The second field also includes, for each of the at least one invoice, the date for which receipt of invoice payment is predicted.

According to another embodiment, the invoice identifies a vendor and the processor is configured to monitor the status of the particular invoice and generate a notification notifying the vendor if the status of the particular invoice has not changed by at least one of the predicted date of status change or the predicted date of status change plus a predefined margin.

According to another embodiment, the predefined margin is at least one of a user selected duration of time, a fixed duration of time, or a margin of error of the predicted date.

According to another embodiment, the status of the one or more events includes at least one of invoice received, pending invoice approval, invoice approved, set for invoice payment, payment approved, payment initiated, payment received, and invoice disputed.

According to another embodiment, the status of the one or more events includes receipt of invoice payment, the plurality of invoices each identify a sum owed by the buyer, and the processor is configured to predict, as of a preselected date, those of the plurality of invoices for which receipt of invoice payment is predicted and a total sum owed includes a summation of the sum owed in each of those invoices.

According to another embodiment, the processor is further configured to output a prediction report. The prediction report includes a first field and a second field. The first field includes a ribbon including the total sum owed. The second field includes a listing of at least one invoice of, as of the preselected date, those of the plurality of invoices for which receipt of invoice payment is predicted.

According to another embodiment, the processor is configured to predict the status of multiple invoices.

According to another embodiment, each invoice in the multiple invoices identifies a vendor and the multiple invoices identify a given vendor.

According to another embodiment, a user selects the multiple invoices.

According to another embodiment, the database includes status information associated with each invoice. The status information includes a current status, a current status update timestamp indicating the date when invoice status was last updated, a list of past statuses, and, for each of the past statuses in the list of past statuses, a past status timestamp indicating the date when the past status was updated.

According to another embodiment, the analysis of the plurality of invoices within the database for the given buyer determines a timeline of events associated with payment of an average invoice by the given buyer.

According to another embodiment, the analysis of the plurality of invoices within the database for the given buyer determines at least one of, from invoice receipt, at least one of an average or median time for: change of status to pending invoice approval, invoice approval, change of status to set for invoice payment, invoice payment approval, invoice payment initialization, receiving invoice payment. The analysis of the plurality of invoices within the database for the given buyer additionally determines at least one of a standard deviation, variance, error, or mean square error of the average time for: change of status to pending invoice approval, invoice approval, change of status to set for invoice payment, invoice payment approval, invoice payment initialization, receiving invoice payment.

According to another embodiment, the particular invoice identifies a particular sum owed and the analysis of the plurality of invoices within the database for the given buyer is performed on invoices including a sum owed similar to the particular sum owed.

A number of features are described herein with respect to embodiments of the invention; it will be appreciated that features described with respect to a given embodiment also may be employed in connection with other embodiments.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a block diagram representing the architecture of an invoice presentment system, an invoice prediction system, and an invoice payment system in accordance with an exemplary embodiment of the present invention;

FIG. 2 is a diagram representing a buyer system in accordance with an exemplary embodiment of the present invention;

FIG. 3 is a diagram representing a vendor system in accordance with an exemplary embodiment of the present invention;

FIG. 4A is a diagram representing an invoice database in accordance with an exemplary embodiment of the present invention;

FIG. 4B is a diagram representing an invoice object in accordance with an exemplary embodiment of the present invention;

FIGS. 5A and 5B are diagrams of reports generated by the invoice status prediction system in accordance with an exemplary embodiments of the present invention;

FIG. 6 is a flow chart representing operation of an aspect of an invoice prediction application in accordance with an exemplary embodiment of the present invention;

FIGS. 7A-7C are diagrams representing analysis of a group of invoices and prediction for a status change of an invoice by the invoice status prediction system in accordance with an exemplary embodiment of the present invention;

FIG. 8 is a ladder diagram representing a combination of data structures and instructions stored in memory and executed by a processor for making invoice status predictions in accordance with an exemplary embodiment of the present invention;

FIG. 9 is a flow chart representing operation of the invoice prediction system to monitor the status of an invoice; and

FIG. 10 is a flow chart representing operation of an aspect of an invoice prediction application in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention provides a system and method for predicting a status change (e.g., receipt of payment) of a particular invoice from among a plurality of invoices within a database, where an invoice status relates to an event occurring in a timeline of events associated with approval and payment of the invoice. Each invoice may have an associated buyer, an associated vendor, and may include an indication of status within the buyer's approval and payment process (e.g., “receipt of invoice” by the buyer, “receipt of invoice payment” by the vendor, etc.). The system and method may predict when the status of the particular invoice will change by analyzing those invoices of the plurality of invoices that are associated with a given buyer, where the given buyer is the buyer associated with the particular invoice. The prediction, for example, may be a function of the date of a previous event in the sequence of events associated with the particular invoice and an average timeline of status change events associated with payment of invoices by the given buyer (e.g., either for the given vendor or invoiced to the given buyer by other vendors).

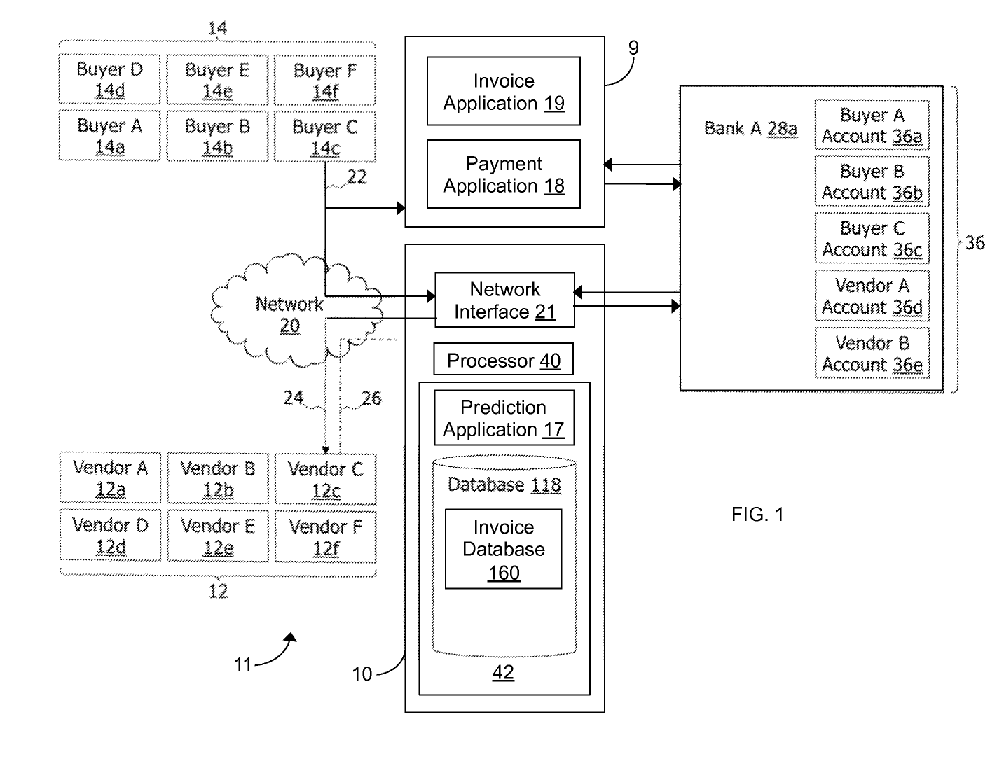

An exemplary architecture 11 including an electronic invoicing and payment system 9 is depicted in FIG. 1. The exemplary electronic invoicing and payment system 9 may include a payment application 18 and an invoice application 19, each of which may be instructions coded to computer readable media and executed by the processor. The electronic invoicing and payment system 9 provides on-line invoice presentment that includes means for reporting invoice approval and payment status to the vendors 12. In general, the invoice application 19 delivers invoices initiated by a vendor 12 to the applicable buyer 14 and includes a reporting function that provides vendors connected to the system 10 with invoice status information. For example, a vendor may submit an invoice to a buyer via the invoicing application. The invoice may then be automatically entered into an accounts receivable system of the buyer. In one example, the status of the vendor may be updated to “received” such that the vendor may view the status of the invoice to verify that the invoice has been received by the buyer. At this point, the buyer may approve the invoice for payment and the status of the invoice may be updated again to “approved for payment” (which the vendor may view). Upon approving the invoice for payment, the system 9 may execute payment from the buyer's account to the vendor. For this purpose, the invoice presentment and payment system 10 may be communicatively coupled to a bank 28a and the bank's payment system.

All actions taken by the buyer associated with payment of an invoice may not be made visible to the associated vendor as a status of the invoice. For example, the electronic invoicing and payment system 9 may allow buyers to designate which statuses are made visible to vendors. The system 9 may also allow buyers 14 to define new statuses that may or may not be visible to vendors 12.

An exemplary electronic invoicing and payment system is further described in U.S. patent application Ser. No. 13/068,558 filed on May 13, 2011, the entire contents of which are incorporated by reference herein. Other exemplary invoice and payment system include systems that utilize automated clearing house (ACH) payments or card payment networks, such as networks operated by Visa, MasterCard, and American Express.

Turning again to FIG. 1, in addition to the electronic invoicing and payment system 9, an invoice status prediction system 10 is shown. The invoice status prediction system 10 may be a computer system of one or more servers comprising at least a processor 40, a network interface 21, and computer readable medium 42. The computer readable medium 42 may include encoded thereon a prediction application 17 and a database 118. The invoice payment prediction application 19 may be a computer program comprising instructions embodied on computer readable medium 42 and executed by the processor 40. The database 118 may include data structures, also referred to as tables, as described herein and may include instructions embodied on computer readable medium 42 for interfacing with the network interface 21 and the prediction application 17 for reading and writing data to the data structures and tables.

The network interface 21 may be communicatively coupled to each buyer 14a-14f of a community of buyers 14 and to each vendor 12a-12f of a community of vendors 12 via a network 20. The network 20 may be an open network, such as the Internet, a private network, such as a virtual private network, or any other suitable network. The network interface 21 may receive invoices and invoice updates from the vendors 12 and/or buyers 14. For example, the network interface 21 may be configured to enable, for a given invoice, updating of the status of at least one event associated with approval and payment of the given invoice based on a received invoice update.

As will be understood by one of ordinary skill in the art, the network interface 21 may comprise a wireless network adaptor, an Ethernet network card, or any suitable device that provides an interface between the system 10 and the network 20.

The invoices and invoice updates received by the network interface 21 may be stored in an invoice database 160 contained in the database 118. The invoices may be stored in the invoice database 160 as records. Each record corresponds to an invoice and may identify an associated vendor, an associated buyer, and contain status information. The invoice database may store records corresponding to different combinations of associated vendors and buyers. The status information may correspond to activity of the associated buyer and/or vendor in relation to a given invoice and may comprise any combination of a current status, a current status update timestamp indicating the date when the invoice status was last updated, a list of past statuses, and, for each of the past statuses in the list of past statuses, a past status timestamp indicating the date when the past status was updated. The records stored in the invoice database 150 may correspond to invoices for which payment has been received (“paid invoices”) and/or invoices for which payment has not been received (“unpaid invoices”). The invoice status updates received by the network interface 21 may be used to update the status of invoices stored in the invoice database 160. For example, the invoice updates may comprise a status update that payment for a given invoice was received. In this example, the current status (e.g., payment initiated) of the given invoice is added to the list of past statuses in the invoice, the current status is updated to “payment received”, and the current status update timestamp is updated to reflect the time and date that payment was received for the invoice.

As will be understood by one of ordinary skill in the art, the database 118 may describe a data structure which embodies groups of records or data elements stored in a volatile or non volatile storage medium and accessed by an application, which may be instructions coded to a storage medium and executed by a processor. The database may comprise multiple individual databases stored on the same storage medium or on multiple different storage media. The system 10 may also store data in and access the database. While the database 118 is depicted as a component of the invoice prediction system 11 in FIG. 1, the database 118 could alternatively be stored on a separate server or locally, e.g., on a buyer's computer and/or a vendor's computer.

The processor 40 may be configured to analyze the plurality of invoices within the database 118 with respect to a given buyer and predict a status change among one or more events associated with approval and payment of a particular invoice among the plurality of invoices associated with the given buyer. For example, the processor 40 may be configured to analyze the plurality of invoices within the database to predict, for the given buyer, a status of a particular invoice or multiple invoices as of a preselected date. The processor may also be configured to analyze the plurality of invoices within the database for the given buyer to predict a date of status change for a given invoice or multiple invoices. The date of status change may represent a predicted date that a status of the particular invoice will change to a defined status.

As will be understood by one of ordinary skill in the art, the processor 40 may have various implementations. For example, the processor 40 may include any suitable device, such as a programmable circuit, integrated circuit, memory and I/O circuits, an application specific integrated circuit, microcontroller, complex programmable logic device, other programmable circuits, or the like. The processor 40 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor.

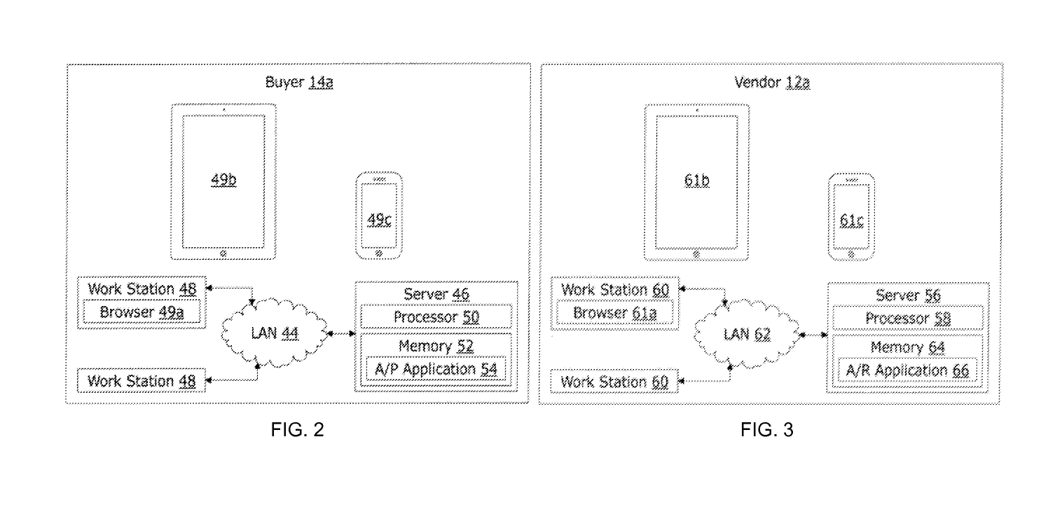

Turning briefly to FIG. 2 in conjunction with FIG. 1, in an exemplary embodiment, each buyer, using buyer 14a for example, may be a business that includes at least one computer system or server 46. The computer system(s) or server(s) 46 may include at least one processor 50 and associated computer readable medium 52 programmed with an accounts payable application 54.

In a typical environment, the computer system(s) or server(s) 46 operating the accounts payable application 54 may be coupled to a local area network 44 and accessed by entitled users of workstations 48 and may be used for managing the buyer's accounts payables and issuing payments to its vendors. Each buyer, again using buyer 14a as an example, may further include one or more access systems for interfacing with the system 10. Exemplary access systems include: i) a web browser 49a on a workstation 48 or other computer which accesses system 10 via a web connection; ii) a tablet computer 49b such as an iPad or Windows Surface which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

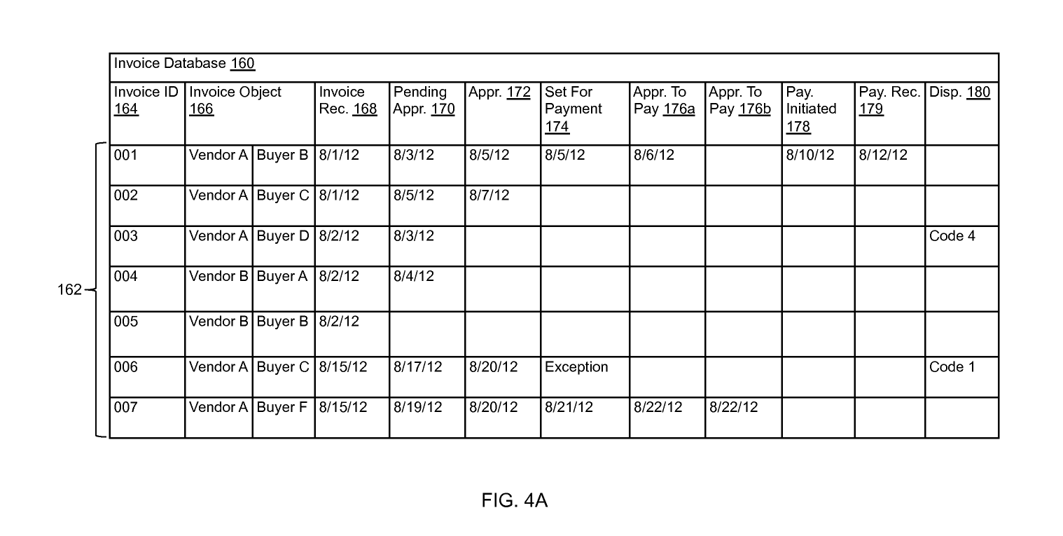

Turning briefly to FIG. 3 in conjunction with FIG. 1, in an exemplary embodiment, each vendor, using vendor 12a for example, may be a business that includes at least one computer system or server 56. The computer system(s) or server(s) 56 may include at least one processor 58 and associated computer readable medium 64 programmed with an accounts receivable application 66.

In a typical environment, the computer system(s) or server(s) 56 operating the accounts receivable application 66 may be coupled to a local area network 62 and accessed by entitled users of workstations 60 and may be used for issuing invoices and managing the vendor's accounts receivables and reconciling payments issued by customers (i.e. buyers) against amounts due to the vendor.

Each vendor, again using vendor 12a as an example, may further include one or more access systems for interfacing with the system 10. Again, exemplary access systems include: i) a web browser 61a on a workstation 60 or other computer which accesses system 10 via a web connection; ii) a tablet computer 61b such as an iPad or Windows Surface which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

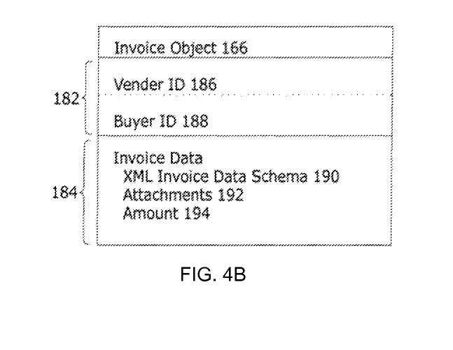

Returning to FIG. 1, for purposes of illustrating the invention, a participating bank 28 is depicted. The bank 28 may include a payment system (i.e. instructions coded to a computer readable medium and executed by a processor) which may manage customer deposit accounts 36a-36e for a portion of the buyers 14a-14f and/or a portion of the vendors 12a-12f, including execution of credit and debit transactions to deposit accounts 36a-26e in a traditional manner. Turning briefly to FIG. 4a in conjunction with FIG. 1, the database 118 may further include, as one of the data structures, the invoice database 160 as described previously. The invoice database 160 may comprise a plurality of records 162, where each record corresponds to an invoice. Each invoice 162 associates a unique invoice ID 164 with a unique invoice object 166 and a group of, e.g., at least three status fields. In the exemplary embodiment, the status fields include an invoice received status field 168, a pending invoice approval status field 170, an invoice approved status field 172, a set for payment status field 174, a first approved to pay status field 176a, a second approved to pay status field 176b, a payment initiated status field 178, a payment received field 179, and a disputed invoice status field 180. As stated previously, the invoice status is not limited to the above listed statuses. For example, the invoice statuses may fall under one of three global statuses (e.g., in process, rejected for processing, ready for payment). As another example, the invoice statuses may include default statuses and/or user defined statuses.

Each status field represents a completed step within a group of processing steps the buyer performs to approve and pay the invoice, whether within the invoice application 19 itself or within the buyer's accounts payable system 43 (FIG. 2) represented by the record 162. For example, the invoice received status field 168 may represent an initial step wherein the buyer has completed receipt of the invoice into his accounts payable system. Additionally, the pending approval status field 170 may represent steps following receipt of the invoice which are performed by the buyer prior to formal approval of the invoice. The approved status field 172 may represent formal approval of the invoice. The set for payment status field 174 may represent a step of setting the payment of the invoice. The first approved to pay status field 176a may represent approval of the payment. The second approved to pay status field 176b may be an optional step representing a second level approval of the payment. The optional step 176b may apply based on buyer's approval rules, for example high value payments may require a second level of approval. The payment initiated status field 178 may represent the buyer initiating the payment through the system 10 by, e.g., issuing a payment file. The payment received status field 179 may represent the vendor's receipt of the payment through the system 10. The disputed status field 180 may represent the buyer disputing all or a portion of the invoice.

Each status field may operate as a status flag for that processing step in that whether the value is populated, or whether a particular value is populated, indicates whether the buyer has completed the processing step. In the exemplary embodiment, each of the status fields 168, 170, 172, 174, 176a, 176b, 178, 179, and 180 may be populated with the status timestamp (i.e., the date that the process was completed).

Turning briefly to FIG. 4B, an exemplary invoice object 166 may comprise a header 182 and a body 184. The header 182 may include a vendor ID 186 and a buyer ID 188 identifying the vendor issuing the invoice and identifying the buyer to which the invoice is to be delivered.

The body 184 of the invoice object includes invoice data. The invoice data may comprise data components of a standardized XML data schema 190—which may be an invoice data schema standardized by the ISO 20022 standard. The invoice data may also include attachments 192 which would typically be PDF files but could be attachments in other file formats which provide more detailed information about invoice line items.

Returning to FIG. 4A, within the records 162 of the invoice database 160 are at least a first invoice object (Invoice ID 001 for example) which includes identification of a first vendor (Vendor A for example) and at least a second invoice object (Invoice ID 004 for example) which includes identification of a second vendor (Vendor B for example) unique from the first vendor. Each vendor is a distinct organization with responsibility for issuing and collecting on its own invoices.

The records 162 of the invoice database 160 may also contain at least one status field 168, 170, 172, 174, 176a, 176b, 178, 179, and 180. For example, there may be multiple fields related to “approval”, with status field 172 representing approval of the invoice (e.g., initial review of the invoice to determine if the invoice represents services rendered to the buyer by the vendor), status field 176a representing approval to pay the sum of money indicated in the invoice, and status field 176b representing a second approval to pay the sum of money indicated in the invoice (e.g., invoices for sums of money greater than $10,000 may require additional approval prior to payment).

Also within the records 162 of the invoice database 160 are at least a first invoice object (Invoice ID 001 for example) which includes identification of a first buyer (Buyer B for example) and at least a second invoice object (Invoice ID 002 for example) which includes identification of a second buyer (Buyer C for example) unique from the first buyer. Each buyer is a distinct organization with responsibility for payment of invoices distinct from other buyers.

For example, the record 162 with an invoice ID 164 of “001” may include an invoice 166 issued by Vendor A to Buyer B. For purposes of illustrating the invention, it is assumed that all processes have been completed and a date is populated to each field. A second level approval step 176b is not required.

The record 162 with an invoice ID of “002” may include an invoice 166 issued by Vendor A to Buyer C. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The record 162 with an invoice ID of “003” may include an invoice 166 issued by Vendor A to Buyer D. For purposes of illustrating the invention, it is assumed that Buyer D has a dispute regarding this invoice. As such only a date is populated to the invoice received status field 168 and a dispute code “Code 4” is populated to the disputed field. A dispute code table 300 may associate a group of dispute codes, for example dispute codes “Code 1”, “Code 2”, “Code 3”, and “Code 4” with a dispute reason. For example, “Code 1” may represent dispute a first reason “Reason A” and “Code 2” may represent a second dispute reason “Reason B”, which is distinct from dispute “Reason A”. A fourth dispute reason “Code 4” may be generic and represent buyer text input of a message to the vendor regarding the basis for the dispute.

Returning to FIG. 4A, the record 162 with an invoice ID of “004” may include an invoice 166 issued by Vendor B to Buyer A. For purposes of illustrating the invention, it is assumed that Buyer A has performed only the first two sequential processing steps (invoice received 168 and pending approval 170). As such, dates are populated for invoice received 168 and pending approval 170. A second level approval step 176b is required for this invoice.

The record 162 with an invoice ID of “005” may include an invoice 166 issued by Vendor B to Buyer B. For purposes of illustrating the invention, it is assumed that Buyer B has performed only the first processing step (invoice received 168). As such, dates are populated for invoice received 168 and pending approval 170. A second level approval step 176b is required for this invoice.

The record 162 with an invoice ID of “006” may include an invoice 166 issued by Vendor A to Buyer B. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required. As will be discussed herein, for this invoice it will be assumed that an exception condition exists with respect to the next sequential step (Set for Payment 174).

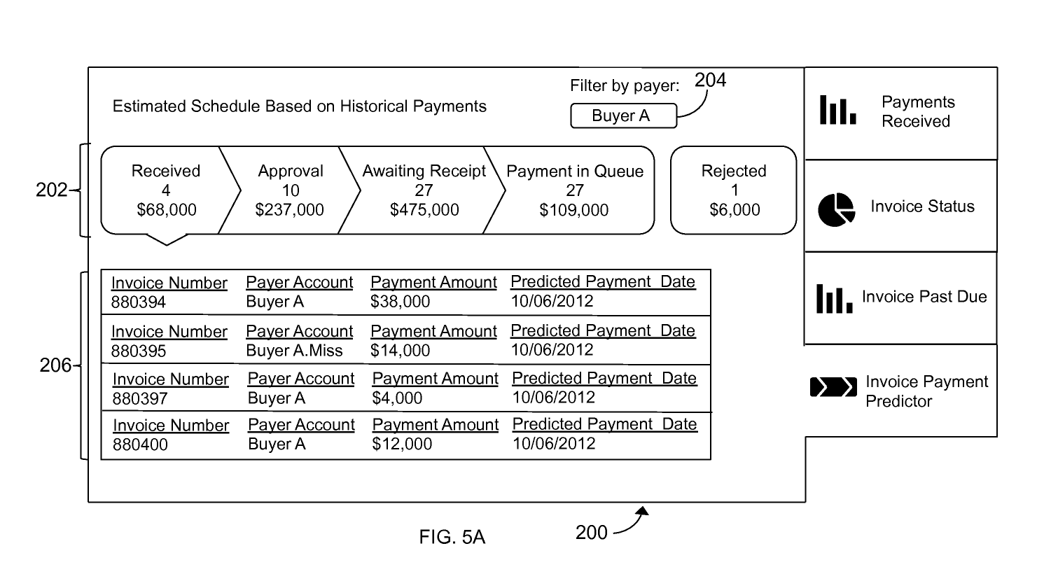

The record 162 with an invoice ID of “007” may include an invoice 166 issued by Vendor A to Buyer F. For purposes of illustrating the invention, it is assumed that the second level approval step 176b is required and that Buyer F has performed all of the sequentially processing steps, including second level pending approval to pay 176b, except for the payment initiated Step 178. As such, dates are populated for invoice received 168, pending approval 170, pending approval 172, set for payment 174, first level pending approval to pay 176a, and second level pending approval to pay 176b. A predicted status change of one or multiple invoices may be graphically reported to a user as depicted in FIG. 5. For example, the processor 40 may be configured to render on a display, using conventional rendering techniques, data regarding the predicted status change. In the current example, the user selects a payer in box 204. In the current example, “Buyer A” is selected. The user may, e.g., select a buyer from a list of buyers or may input the name of the buyer into the box 204.

Predictions for invoices associated with both the selected buyer and the vendor user are displayed in a report 200. In the report 200, a ribbon 202 containing multiple statuses is presented to the user. The user may select a given status on the ribbon 202 to display predictions for invoices having the same current status as the selected status on the ribbon 202. For example, in FIG. 5A, the status “Received” is selected and four invoices having a status of received by Buyer A are displayed in a prediction table 206. Statuses for “Approval”, “Awaiting Receipt”, “Payment in Queue”, and “Rejection” are also available in the current example. For the four invoices having a current status of “received”, a predicted date that the invoice will be paid is provided in the prediction table 206. All four invoices displayed in the prediction table 206 have a predicted payment date of Oct. 6, 2012. The predicted dates in the prediction table 206 are not required to have the same predicted date and may contain different dates. The payment amount for each invoice is also displayed in the prediction table. The sum of the payment amount for all four invoices is also displayed in the ribbon 202.

Turning to FIG. 5B, a graphical report regarding unpaid invoices that are predicted to be paid by a selected date is shown. In the current example, Buyer A″ and a date of “Nov. 11, 2012” are selected. The user may, e.g., select a date from a displayed calendar or may input the date into a text box 210. Predictions for invoices associated with the selected buyer, the vendor user, and for which payment is predicted to be received by the selected date are displayed in the report 200. In the report 200, the ribbon 202 describes the number of invoices for which payment is predicted to be received by Nov. 11, 2012. For the thirteen invoices for which payment is predicted to be received by Nov. 11, 2012, the predicted date that payment will be received for each is provided in the prediction table 206. Only four invoices are currently visible in the prediction table 206, however the other nine invoices may also be viewed using a scroll bar 212. The payment amount for each invoice is also displayed in the prediction table. The sum of the payment amount for all thirteen invoices is also displayed in the ribbon 202.

The status “approval” in FIGS. 5A and 5B may correspond to invoices having a status of invoice approved 172 as defined in FIG. 4A. The status “awaiting receipt” in FIGS. 5A and 5B may correspond to invoices having a status of invoice approved 172 as defined in FIG. 4A, but further invoice processing is on hold awaiting receipt/approval of, e.g., shipped goods. The status “payment in queue” in FIGS. 5A and 5B may correspond to invoices being in the buyer's queue for paying the vendor, which may correspond to a status of set for payment 174, approved to pay 176a, 176b, or payment initiated 178 as defined in FIG. 4A. The status “rejection” in FIGS. 5A and 5B may correspond to invoices having a status of disputed 180 as defined in FIG. 4A.

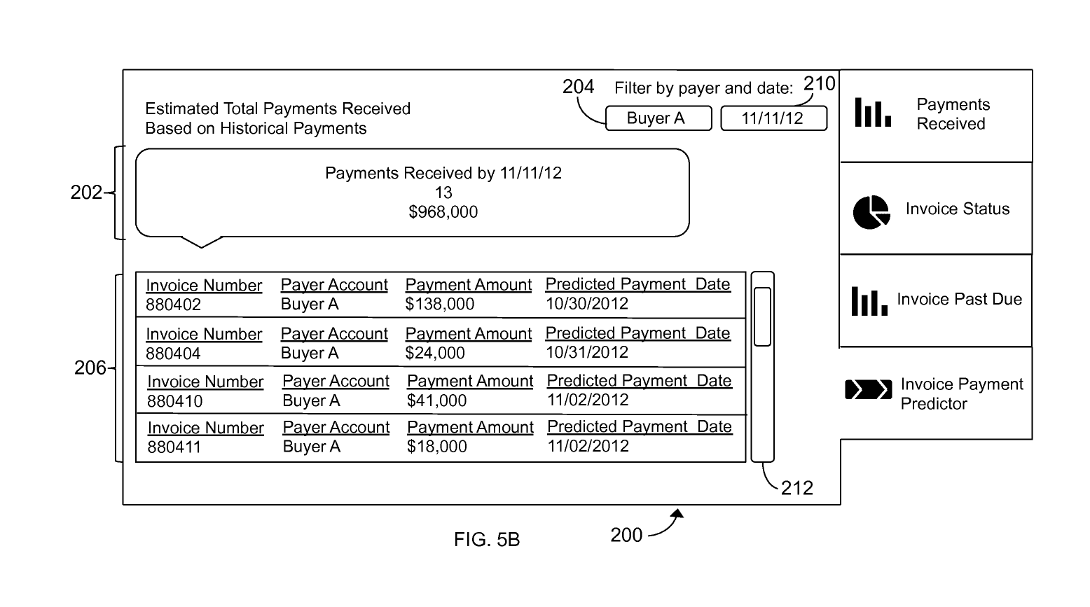

Turning to FIG. 6, exemplary processing steps of the prediction application 17 are shown. The steps may be performed, e.g., in response to a request from a vendor 12. In process block 502, the prediction application 17 may receive a group of invoices or an indication of a group of invoices. For example, a user may specify a buyer and an invoice status as depicted in FIG. 5A using a keyboard, touchscreen, or any other suitable means for data input. The prediction application may then receive and/or retrieve from the invoice database 160 a list of invoices matching this criteria—i.e., identifying the user as the vendor, identifying the selected buyer, and having the selected invoice status. As an example, in FIG. 5 the user selected “Buyer A” and invoices having a status of “Received”. In process block 504, the prediction application 17 may select the first invoice from the group of invoices. In process block 504 the prediction application receives a particular invoice (e.g., the first invoice) or an indication of the particular invoice (e.g., information sufficient to retrieve the first invoice from the invoice database 160). In process block 506, the prediction application determines the buyer associated with the particular invoice.

In process block 510 the prediction application 17 analyzes a plurality of invoices stored in the invoice database 160 that are associated with the buyer of the particular invoice. The prediction application 17 may analyze the plurality of invoices associated with the buyer in order to determine a timeline of events associated with payment of an average invoice by the given buyer. For example, based on the analysis of the plurality of invoices within the database for the given buyer, the prediction application 17 may determine, from invoice receipt, at least one of an average or median time for a change of status to: pending invoice approval, invoice approval, set for invoice payment, payment approval, payment initialization, and payment receipt. The prediction application 17 may also determine a standard deviation, variance, error, or mean square error of the average time for a change of status to: pending invoice approval, invoice approval, set for invoice payment, payment approval, payment initialization, and payment receipt. Based upon this data, the prediction application 17 may determine an average invoice timeline for the buyer associated with the particular invoice.

As will be understood by one of ordinary skill in the art, analysis of the invoices associated with a given buyer may be performed using any suitable method. For example, analysis may comprise regression analysis, the use of pattern recognition algorithms, or other suitable statistical techniques taking as an input one or more of the time duration between status changes, invoice payment amount, vendor identity, date, or any other suitable data regarding invoice activity of the given buyer.

Analysis need not be performed on all of the plurality of invoices associated with the buyer. As will be understood by one of ordinary skill in the art, analysis may be performed on a limited subset of the invoices associated with the buyer. The limited subset of invoices may be those invoices meeting a suitable criteria. For example, analysis may be performed on one or more of the most recent invoices, the invoices associated with the user, and the invoices indicating a sum owed (i.e., a payment amount) similar to the sum owed of the particular invoice.

Based on the analysis of the plurality of invoices, in process block 512, the prediction application predicts a status change of an event or multiple events associated with payment of the particular invoice. For example, the prediction application may predict the status of one or more invoices as of a preselected date. Alternatively, the prediction application may predict a date of status change, the date of status change representing a predicted date that a status of the particular invoice or multiple invoices will change to a defined status. For example, the prediction application 17 may predict the plurality of invoices associated with the vendor for which payment will be received by a preselected date as well as the total amount of money that will be received from payment of the invoices.

Prediction of invoice status for a particular invoice may be a function of one or more of invoices and invoice updates received via the network interface, the information in the particular invoice (e.g., the date of status change for one or more events in relation to the particular invoice), the analysis performed regarding the other invoices associated with the buyer in the database, and any other suitable data regarding the particular invoice.

Prediction of invoice status is not limited to the prediction of status for one invoice or for invoices associated with a single buyer. As will be understood by one of ordinary skill in the art, the system 10 may predict the status of multiple invoices for multiple buyers. For example, a vendor may select a list of invoices for which prediction is requested.

For example, based on invoice creation date, current invoice status, past status update timestamp (i.e., the date when the invoice status was previously updated), and the analysis of other invoices associated with the buyer of the invoice of interest, the system may provide a prediction for one or more invoices predicting when the invoice of interest is expected to be paid. However, if insufficient invoices associated with a given buyer are available for the given buyer, then a prediction may not be displayed. Status prediction may be performed on the per-buyer level (i.e., each particular invoice has the same buyer) or on a global basis (i.e., the particular invoices have different buyers).

The predicted status change may be displayed to the user in process block 516. The predicted status change may be displayed to the user in a report (e.g., as depicted in FIG. 5) or, as will be understood by one of ordinary skill in the art, in any other suitable manner. For example, the report may be displayed on a web page, in a document emailed to the user, in a window of an application, or using any other suitable means. In determining block 518, if a group of invoices was selected or received for prediction, a determination is made if a status change has been predicted for all of the invoices in the group. If invoices remain, the next invoice may be selected from the group of invoice in process block 520.

With further reference to FIG. 6, in process block 514, the prediction application may optionally monitor the status of the particular invoice. For example, the vendor may request to be notified if the status of the particular invoice does not change as predicted (e.g., representing that the buyer never received the invoice or the invoice contained an error). If the status of the particular invoice does not change, the vendor may be notified as of the predicted date of status change or the predicted date of status change plus a predefined margin. The predefined margin may consist of a user selected duration of time, a fixed duration of time, a margin of error of the predicted date, or any other suitable duration of time. Monitoring the status of an invoice may be requested by the vendor or may be performed automatically by the invoice prediction system 10.

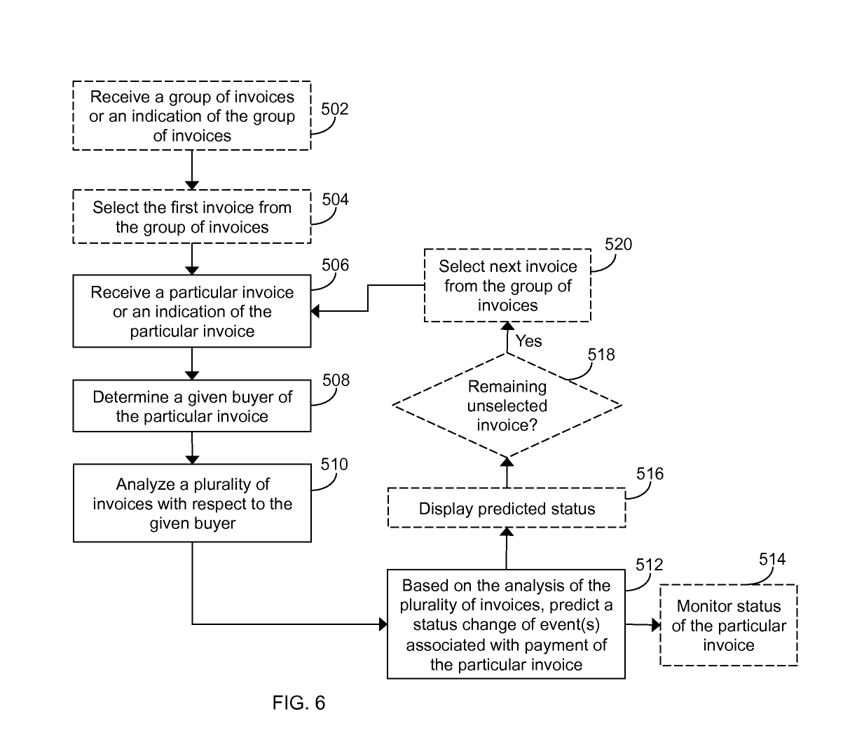

Turning to FIGS. 7A-7C, in conjunction with FIG. 6, in an exemplary embodiment, the invoice status prediction system 10 may generate an analysis object 300 for a given buyer and an invoice prediction object 400 for a given invoice based on the analysis object 300. An invoice analysis object 300 may be generated in process block 510 in FIG. 6. For example, in FIG. 7B, the invoice analysis object 300 is generated prior to prediction of a status change for an invoice 162. In the example, a prediction request has been received regarding invoice 162. As described in process block 508, the buyer of the invoice is determined (Buyer B) and an analysis is performed on a plurality of invoices associated with Buyer B. The invoice analysis object 300 may contain an average time duration 302, median time duration 304, and standard deviation of the average time duration 306 for a change of status, from the previous status, to: pending approval 310, invoice approval 312, set for payment 314, approval to pay invoice 316, payment initialization 318, and payment receipt 320.

Based on the invoice analysis object 300 (i.e., the average time duration 302 and the median time duration 304), the invoice status prediction system 10 may predict the date of status change to: pending approval 410, invoice approval 412, set for payment 414, approval to pay invoice 416, payment initialization 418, and payment receipt 420. The prediction may be performed based on the average duration of time 404 and/or median duration of time 406. The predicted date of status change is shown in FIG. 7C using both the average time duration 404 and the median time duration 406. As described previously, other methods are contemplated for analyzing the plurality of invoices associated with a buyer and predicting the status of an invoice.

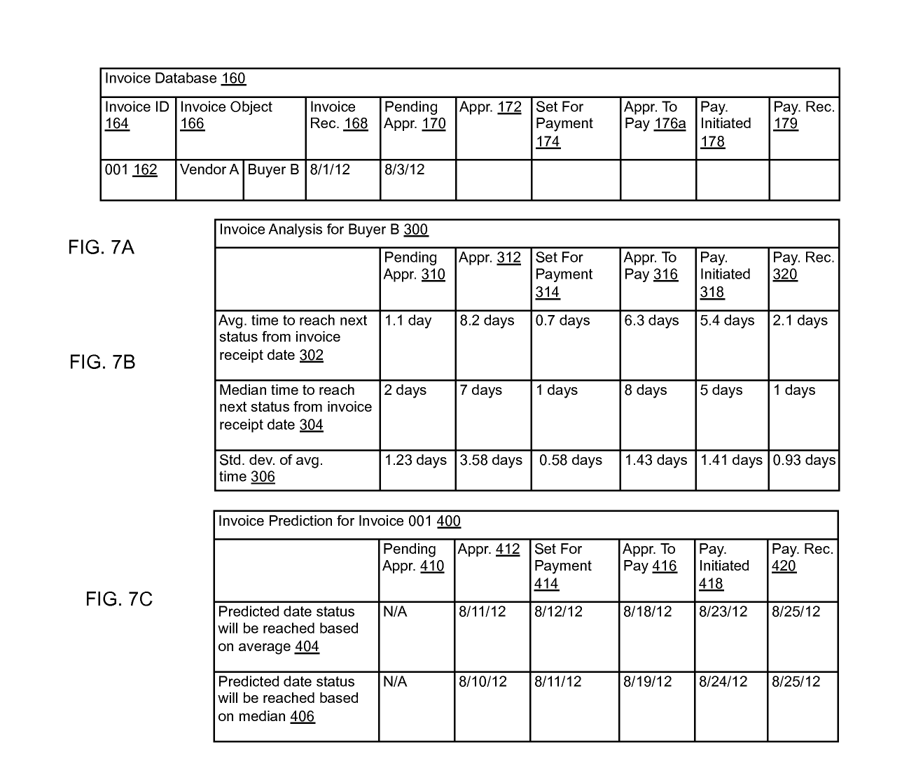

Referring to the ladder diagram of FIG. 8 in conjunction with FIG. 1, in an exemplary embodiment of operation, the invoice status prediction system 10 receives an invoice update file 530 from a buyer 14. For example, the invoice update file 530 may be automatically generated by the accounts payable software of the buyer 14. The invoice update file 530 identifies the invoice that is to be updated by the invoice update file 530. The invoice may be identified by invoice ID number or a combination of other data, e.g., associated buyer, associated vendor, and payment amount. The invoice update file 530 may be transferred via a secure connection over the network 20 which may include implementing encryption of the connection and/or the file transferred over the connection.

Upon receiving and authenticating the invoice update file 530, in step 532, the invoice status prediction system 10, or more specifically, the processor 40 executing the prediction application 17, updates the invoice in the invoice database 160 that is to be updated by the invoice update file 530.

In step 534, the invoice prediction system may receive a prediction request file 534 from the vendor 14. The prediction request file 534 may identify one or more invoices or specify criteria based upon which the system 10 can identify one or more invoices stored in the invoice database 160. The prediction request file 534 may also specify a requested status and/or a requested date. The requested status and/or requested date may be used by the system 10 in step 538. Upon receiving the prediction request file 534, in step 536, the system 10 analyzes the invoices stored in the invoice database 160 in order to predict a status of the invoices identified and/or contained in the prediction request file 534. In step 538, a status prediction is determined for the invoice or invoices identified in the prediction request 534. A prediction file 540 including the status prediction is transferred to the vendor 14.

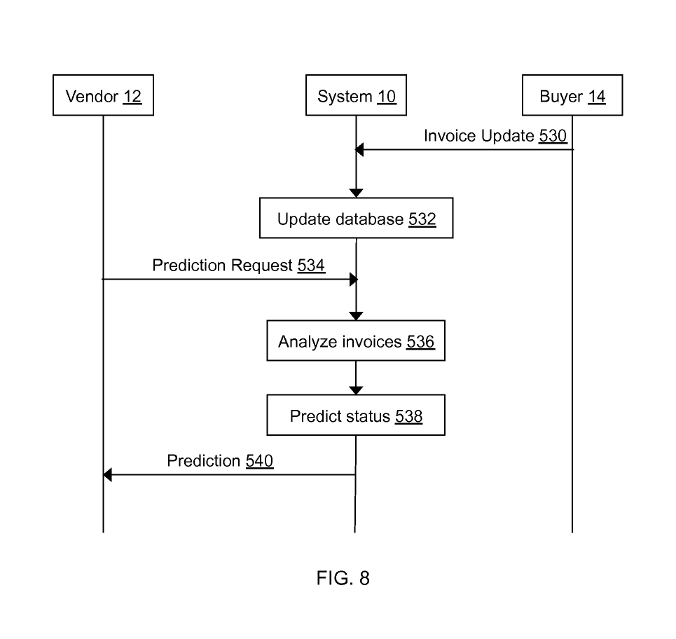

In FIG. 9, monitoring the status of the particular invoice is further described. In process block 550, the prediction application monitors the date to determine if the predicted date of status change has been reached. When the predicted date of status change is reached, the status of the particular invoice is checked in determining block 552. If the status of the particular invoice has not been updated as of the predicted date of status change, in step 554, the prediction application 17 may generate a notification notifying the vendor that the status of the particular invoice has not changed by at least one of the predicted date of status change or the predicted date of status change plus a predefined margin. The notification may include an email message, an SMS message, or any other suitable method of notifying a user.

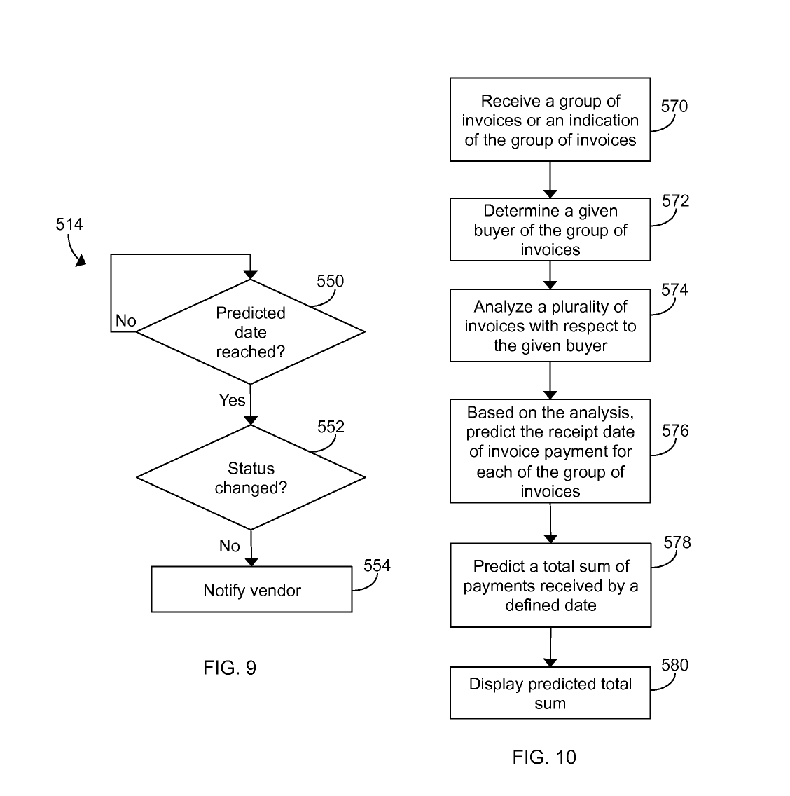

With reference to FIG. 10, another example of the processing steps of the prediction application 17 are shown. In block 570, the prediction application receives a group of invoices or an indication of a group of invoices having a common buyer. After determining the buyer of the invoices in block 572, the prediction application analyzes a plurality of invoices stored in the invoice database 160 that are associated with the buyer of the particular invoice in process block 574. Based on the analysis of the plurality of invoices, in process block 576, the prediction application predicts, for each of the particular invoices in the group of particular invoices, the receipt date of invoice payment for each particular invoice. In process block 578, a predicted total sum received in payment for each of the particular invoices is determined for a given date and displayed to the user in process block 580.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. An invoice status prediction system comprising:
a database encoded to a non-transitory computer readable medium, the database including a plurality of records, each representing an invoice, a portion of which are unpaid invoices, at least a first portion of the invoices relating to invoice activity of a first buyer and at least a second portion of the invoices relating to invoice activity of a second buyer;
a network interface configured to enable updating a status of at least one event among multiple events occurring in a timeline of events associated with payment of at least one invoice of the plurality of invoices; and
a processor configured to analyze the plurality of invoices within the database with respect to a given buyer and predict a status change among one or more events associated with payment of a particular invoice among the plurality of invoices by the given buyer.

2. The invoice status prediction system of claim 1, wherein the processor is configured to analyze the plurality of invoices within the database for the given buyer to predict a status of the particular invoice as of a preselected date.

3. The invoice status prediction system of claim 2, wherein the processor is configured to predict, for the given buyer, a status of multiple invoices as of the preselected date.

4. The invoice status prediction system of claim 1, wherein the processor is configured to analyze the plurality of invoices within the database for the given buyer to predict a date of status change, the date of status change representing a predicted date that a status of the particular invoice will change to a defined status.

5. The invoice status prediction system of claim 4, wherein the processor is configured to predict, for each of multiple invoices corresponding to the given buyer, the date of status change to the defined status.

6. The invoice status prediction system of claim 5, the processor further configured to output a prediction report, the prediction report comprising:
a first field comprising a ribbon including multiple statuses, wherein one status of the multiple statuses is selected as a selected status; and
a second field including:
a listing of at least one invoice, a current status of the at least one invoice corresponding to the selected status, from the plurality of invoices corresponding to the given buyer; and
for each of the at least one invoice, the date for which receipt of invoice payment is predicted.

7. The invoice status prediction system of claim 4, wherein the invoice identifies a vendor and the processor is configured to:
monitor the status of the particular invoice; and
generate a notification notifying the vendor if the status of the particular invoice has not changed by at least one of the predicted date of status change or the predicted date of status change plus a predefined margin.

8. The invoice status prediction system of claim 7, wherein the predefined margin is at least one of a user selected duration of time, a fixed duration of time, or a margin of error of the predicted date.

9. The invoice status prediction system of claim 1, wherein the status of the one or more events comprises at least one of invoice received, pending invoice approval, invoice approved, set for invoice payment, payment approved, payment initiated, payment received, and invoice disputed.

10. The invoice status prediction system of claim 9, wherein:
the status of the one or more events comprises receipt of invoice payment;
the plurality of invoices each identify a sum owed by the buyer; and
the processor is configured to predict, as of a preselected date, those of the plurality of invoices for which receipt of invoice payment is predicted and a total sum owed comprising a summation of the sum owed in each of those invoices.

11. The invoice status prediction system of claim 9, the processor further configured to output a prediction report, the prediction report comprising:
a first field comprising a ribbon including the total sum owed; and
a second field including a listing of at least one invoice of, as of the preselected date, those of the plurality of invoices for which receipt of invoice payment is predicted.

12. The invoice status prediction system of claim 1, wherein the processor is configured to predict the status of multiple invoices.

13. The invoice status prediction system of claim 12, wherein each invoice in the multiple invoices identifies a vendor and the multiple invoices identify a given vendor.

14. The invoice status prediction system of claim 12, wherein a user selects the multiple invoices.

15. The invoice status prediction system of claim 1, wherein the database includes status information associated with each invoice, wherein the status information comprises a current status, a current status update timestamp indicating the date when invoice status was last updated, a list of past statuses, and, for each of the past statuses in the list of past statuses, a past status timestamp indicating the date when the past status was updated.

16. The invoice status prediction system of claim 1, wherein the analysis of the plurality of invoices within the database for the given buyer determines a timeline of events associated with payment of an average invoice by the given buyer.

17. The invoice status prediction system of claim 16, wherein the analysis of the plurality of invoices within the database for the given buyer determines at least one of:
from invoice receipt, at least one of an average or median time for change of status to pending invoice approval;
from invoice receipt, at least one of an average or median time for invoice approval;
from invoice receipt, at least one of an average or median time for change of status to set for invoice payment;
from invoice receipt, at least one of an average or median time for invoice payment approval;
from invoice receipt, at least one of an average or median time for invoice payment initialization;
from invoice receipt, at least one of an average or median time for receiving invoice payment;
a standard deviation, variance, error, or mean square error of the average time for changing status to pending invoice approval;
a standard deviation, variance, error, or mean square error of the average time for invoice approval;
a standard deviation, variance, error, or mean square error of the average time for changing status to set for invoice payment;
a standard deviation, variance, error, or mean square error of the average time for invoice payment approval; and
a standard deviation, variance, error, or mean square error of the average time for invoice payment initialization; and
a standard deviation, variance, error, or mean square error of the average time for receiving invoice payment.

18. The invoice status prediction system of claim 1, wherein the particular invoice identifies a particular sum owed and the analysis of the plurality of invoices within the database for the given buyer is performed on invoices including a sum owed similar to the particular sum owed.

19. The invoice status prediction system of claim 1, wherein the non-transitory computer readable medium to which the database is encoded is located in a computer server.

20. The invoice status prediction system of claim 1, wherein the non-transitory computer readable medium to which the database is encoded is located in at least one of a buyer's computer and a vendor's computer.

21. A server for predicting invoice status comprising:
a database encoded to a non-transitory computer readable medium, the database including a plurality of records, each representing an invoice, a portion of which are unpaid invoices, at least a first portion of the invoices relating to invoice activity of a first buyer and at least a second portion relating to invoice activity of a second buyer;
a network interface configured to enable updating a status of at least one event among multiple events occurring in a timeline of events associated with payment of at least one invoice of the plurality of invoices; and
a processor configured to analyze the plurality of invoices within the database with respect to a given buyer and predict a status change among one or more events associated with payment of a particular invoice among the plurality of invoices by the given buyer.
